(19) United States
(12) Patent Application Publication
(10) Pub. No.: US 2025/0368210 A1
(43) Pub. Date: Dec. 4, 2025

(54) DRIVING COMFORT EVALUATION METHOD FOR UNEVEN SETTLEMENT OF ROAD-BRIDGE TRANSITION SECTION IN SOFT SOIL AREA

(71) Applicants: Zhejiang University, Hangzhou (CN); Zhejiang Institute of Communications Co., Ltd, Hangzhou (CN)

(72) Inventors: Zhongxuan Yang, Hangzhou (CN); Haojie Wu, Hangzhou (CN); Chaofa Zhao, Hangzhou (CN); Bing Duan, Hangzhou (CN); Bin Mao, Hangzhou (CN); Huaiwu Zeng, Hangzhou (CN)

(21) Appl. No.: 19/218,577

(22) Filed: May 26, 2025

(30) Foreign Application Priority Data
May 31, 2024 (CN) 202410696641.9

(51) Int. Cl. B60W 50/00; B60W 40/08

(52) U.S. Cl. CPC B60W 50/0098; B60W 40/08; B60W 2050/0031; B60W 2520/105; B60W 2552/05; B60W 2552/40; B60W 2556/10

(57) ABSTRACT

Disclosed is a driving comfort evaluation method for uneven settlement of a road-bridge transition section in a soft soil area, including the steps of: establishing a vehicle finite element model; obtaining vertical instantaneous vibration acceleration data of a vehicle body in a vehicle driving process; calculating a weighted acceleration root mean square value curve; and calculating a driving annoyance rate as a unified evaluation index of driving comfort of uneven settlement of a road-bridge transition section in a soft soil area. According to the calculated driving annoyance rate, that is, a proportion of people who feel unacceptable annoyance in the vehicle driving process to a total number of people, and the driving comfort of uneven settlement of a road-bridge transition section in a soft soil area can be scientifically evaluated, providing a strong basis and scientific guidance for the design, construction and maintenance of road and bridge projects.

### CROSS-REFERENCE TO RELATED APPLICATION

This application claims priority of Chinese Patent Application No. 202410696641.9, filed on May 31, 2024, the entire contents of which are incorporated herein by reference.

### TECHNICAL FIELD

The present disclosure relates to the technical field of traffic engineering, and in particular relates to a driving comfort evaluation method for uneven settlement of a road-bridge transition section in a soft soil area.

### BACKGROUND

With the rapid development of economy, the construction of transportation infrastructure has also continued to grow. In the process of highway construction, it is inevitable that a large number of areas where roads and bridges connect will appear, that is, road-bridge transition sections. Due to the difference of stiffness between foundation soil and bridge structure, and the inhomogeneity of soil, uneven settlement often occurs in the road-bridge transition sections, which is especially common and serious in soft soil areas. This uneven settlement will seriously affect the driving comfort, forming the so-called “bumping at bridgehead” phenomenon, that is, the vehicle will have an obvious bumpy feeling when passing through this area.

However, there is no ready-made method or complete software to evaluate the driving comfort of uneven settlement of a road-bridge transition section in a soft soil area. Therefore, it is of great significance to develop an effective evaluation method for evaluating and improving the driving comfort of a road-bridge transition section in a soft soil area.

At present, some scholars have used four-degree-of-freedom and five-degree-of-freedom vehicle theoretical models to study the driving comfort of uneven settlement in a road-bridge transition section. For example, the use of a four-degree-of-freedom vehicle model is provided in a doctoral dissertation (Gao Zhiwei, RESEARCH ON EQUILIBRIUM SETTLEMENT CONTROL OF HIGHWAY SOFT FOUNDATION TRANSITION SECTION BASED ON RIDE COMFORT, Doctoral Dissertation of Chang'an University, 2012); and the use of five-degree-of-freedom vehicle model is provided in a literature (Chen Renpeng, Jia Ruiyu, Jiang Zhenghui, Zhang Haizhong, ANALYSIS OF VEHICLE-ROAD INTERACTION AND LONGITUDINAL ROAD DESIGN UNDER UNEVEN SETTLEMENT CONDITIONS, China Journal of Highway and Transport, Vol. 30, No. 4, April 2017). However, these theoretical vehicle models can not accurately simulate the real vibration of vehicles, and can not well represent the problem of vehicle driving comfort. Therefore, it is of great significance to develop a method that can scientifically and accurately evaluate the driving comfort of uneven settlement in a road-bridge transition section.

### SUMMARY

Given the deficiency of the related art, the present disclosure utilizes vehicle multi-body dynamics simulation, considers the objective vibration and the subjective feeling of the comfort of the human body in a vehicle driving process, takes a driving annoyance rate as an evaluation index, and establishes a driving comfort evaluation method for uneven settlement of a road-bridge transition section in a soft soil area.

The present disclosure firstly provides a driving comfort evaluation method for uneven settlement of a road-bridge transition section in a soft soil area, including the following steps:
(1) establishing a vehicle finite element model according to vehicle parameters;
(2) inputting uneven settlement data and road information of the road-bridge transition section into the vehicle finite element model in step (1) as road parameters;
(3) using the vehicle finite element model after inputting the road parameters in step (2) to perform dynamic simulation analysis, simulating a driving process of a vehicle on an uneven settlement road in the road-bridge transition section, and obtaining vertical instantaneous vibration acceleration data of a vehicle body in the driving process of the vehicle through simulation analysis;
(4) calculating a weighted acceleration root mean square curve according to the vertical instantaneous vibration acceleration data of the vehicle body obtained by the simulation analysis in step (3);

(5) calculating the maximum weighted acceleration root mean square value in the driving process of the vehicle on the uneven settlement road in the road-bridge transition section as a representative weighted acceleration root mean square value according to the weighted acceleration root mean square curve obtained in step (4); and

(6) calculating a driving annoyance rate as a unified evaluation index of driving comfort of uneven settlement of road-bridge transition section in the soft soil area according to the representative weighted acceleration root mean square value obtained in step (5), combined with an annoyance rate model, and considering the randomness of human subjective feeling and the fuzziness of brain determination.

Preferably, in step (1), the vehicle is a family car. The vehicle finite element model includes a vehicle body system, a front suspension system, a rear suspension system, a front tire system, a rear tire system and a dynamic system. The vehicle finite element model can be constructed using methods commonly used in the related art, for example, a vehicle dynamics design analysis software Adams/Car can be used.

Preferably, in step (2), the uneven settlement of the road-bridge transition section of a road center line is assumed to be ideal staggered platform type, ideal curve type, ideal polyline type or measured highway surface settlement data. In this disclosure, some ideal model data or actual measured data can be used for the uneven settlement data of the road-bridge transition section of the road center line.

The uneven settlement data of the road-bridge transition section is longitudinal surface elevation data of the road, and that is, a surface uneven settlement curve of the road-bridge transition section.

Preferably, in step (2), the road information is roughness and friction coefficient. The roughness and friction coefficient include the roughness and friction coefficient of a bridge deck and the roughness and friction coefficient of a pavement. Data on the bridge deck side and data on the pavement can take the same value, or can take different values.

As for the roughness, the pavement can be divided into different grades according to the unevenness of the pavement, and the pavement spectrum of high-grade highways in China is basically within the range of Grade A, Grade B and Grade C.

As for the friction coefficient, the friction coefficient of dry asphalt pavement is generally 0.6-0.9, the friction coefficient of wet asphalt pavement is generally 0.4-0.6, the friction coefficient of concrete pavement is generally 0.5-0.8, and the friction coefficient of wet concrete is generally 0.3-0.5. Generally, the pavement is valued according to the asphalt pavement, and the bridge deck is valued according to the concrete pavement.

Preferably, in step (3), a set vehicle driving speed is 60-120 km/h when the dynamic simulation analysis is performed. Generally, when the vehicle driving speed is slow, the uneven settlement of the road-bridge transition section in the soft soil area has little influence on driving comfort. Therefore, setting the vehicle driving speed too low is of relatively little significance. Of course, it is actually necessary, and the vehicle driving speed can also be set to a value less than 60km/h. While the maximum vehicle driving speed is generally not more than 120 km/h, so it is not necessary to set it higher. Of course, it is actually necessary, the vehicle driving speed can also be set to a value greater than 120 km/h.

Preferably, in step (4), the weighted acceleration root mean square value is a_{w}, and a calculation formula is as follows:

$${a}_{w} ( t ) = {[ {\int }_{0.5}^{80} {( W ( u ) \cdot \vert {y}^{\tilde{¨}} ( u ) \vert )}^{2} d u ]}^{\frac{1}{2}}$$

where t represents a certain moment; a_{w}(t) represents a weighted acceleration root mean square value at t; u is a frequency and an integral variable, with a value interval of 0.5-80; and ∫is an integral symbol and d is a differential symbol;
[symbol] (u) is the vertical instantaneous vibration acceleration of the vehicle body in a frequency domain frequency history, [symbol] (u) is obtained by converting the vertical instantaneous vibration acceleration of the vehicle body from a time domain to a frequency domain through Fourier transform in a time period of [t-τ, t];
where τ is a continuous average integration time;

W(u) is a frequency domain weighting function, and the frequency domain weighting function W(u) is expressed as follows:

$$W ( u ) = \{ \begin{matrix}0.5 & ( 0.5 \leq u \leq 2. ) \\ u / 4 & ( 2. < u \leq 4. ) \\ 1 & ( 4. < u \leq 12.5 \\ 12.5 / u & ( 12.5 < u \leq 80. )\end{matrix}$$

More preferably, in step (6), the driving annoyance rate A(a′_{w}) is calculated as follows:

$$A ( {a}_{w}^{′} ) = {\int }_{0.315}^{∞} f ( rms \vert {a}_{w}^{′} ) \cdot v ( rms ) \cdot d ( rms )$$

in the above formula,

$${a}_{w}^{′}$$

is and objective vibration acceleration, and rms is a vibration acceleration felt by the human body, and an integral variable, with a value interval of 0.315-∞;

$$f ( rms \vert {a}_{w}^{′} )$$

represents a probability density function of the root mean square value rms of acceleration felt by the random variable human body under a condition that a root mean square value of the objective vibration weighted acceleration is

$${a}_{w}^{′} ;$$

∫is the integral symbol and d is the differential symbol;

where ν is a membership function, and an expression is as follows:

$$v ( rms ) = a \cdot ln ( rms ) + b$$

where a and b are fitting coefficients.

Further preferably, under a stimulation of the objective vibration acceleration

$${a}_{w}^{′} ,$$

a random variable rms conforms to lognormal distribution, and a variable coefficient is 0.1-0.5. The variable coefficient is most preferably 0.3.

The present disclosure also provides a driving comfort evaluation device for uneven settlement of a road-bridge transition section in a soft soil area, including a vehicle finite element model construction unit, a dynamic simulation analysis unit, a weighted acceleration root mean square value calculation unit and a driving trouble rate calculation unit;
the vehicle finite element model building unit is configured to establish a vehicle finite element model according to vehicle parameters, and further input uneven settlement data and road information of a road-bridge transition section into the vehicle finite element model as road parameters;
the dynamic simulation analysis unit is configured to perform dynamic simulation analysis using the vehicle finite element model after inputting the road parameters, simulate a driving process of the vehicle on an assumed ideal staggered platform type uneven settlement road of a road-bridge transition section, and obtain vertical instantaneous vibration acceleration data of a vehicle body in the driving process of the vehicle through simulation analysis;
the weighted acceleration root mean square value calculating unit is configured to calculate a weighted acceleration root mean square value curve according to the vertical instantaneous vibration acceleration data of the vehicle body obtained by simulation analysis; and calculate the maximum weighted acceleration root mean square value in the driving process of the vehicle on the uneven settlement road in the road-bridge transition section as a representative weighted acceleration root mean square value according to the obtained weighted acceleration root mean square curve; and
the driving annoyance rate calculation unit calculates the driving annoyance rate as a unified evaluation index of driving comfort of uneven settlement of road-bridge transition section in the soft soil area according to the obtained representative weighted acceleration root mean square value, combined with an annoyance rate model, and considering the randomness of human subjective feeling and the fuzziness of brain determination.

The present disclosure also provides a driving comfort evaluation device for uneven settlement of a road-bridge transition section in a soft soil area, including a memory and a processor. The memory is used for storing a computer program, and the processor is used for implementing the driving comfort evaluation method for uneven settlement of a road-bridge transition section in a soft soil area when the computer program is executed.

According to the driving comfort evaluation method for uneven settlement of a road-bridge transition section in a soft soil area provided by the present disclosure, by using the multi-body dynamics simulation of vehicles, considering the objective vibration and the subjective feeling of the comfort of the human body in the vehicle driving process, and taking the driving annoyance rate as the evaluation index, based on the calculated driving annoyance rate, that is, a proportion of people who feel unacceptable annoyance in the vehicle driving process among a total number of people, and the driving comfort of uneven settlement of a road-bridge transition section in a soft soil area can be scientifically evaluated, providing a strong basis and scientific guidance for the design, construction and maintenance of road and bridge projects.

### BRIEF DESCRIPTION OF THE DRAWINGS

FIG. 1 is a flowchart of a driving comfort evaluation method for uneven settlement of a road-bridge transition section in a soft soil area according to the present disclosure.

FIG. 2 is a vehicle finite element model diagram established in an example.

FIG. 3 is an elevation diagram of uneven settlement of a road center line of a road-bridge transition section in the example.

FIG. 4 is a vertical instantaneous vibration acceleration data diagram of a vehicle body calculated by dynamic simulation analysis in the example.

FIG. 5 is a graph of weighted acceleration root mean square values calculated in the example.

### DETAILED DESCRIPTION

Technical solutions in the examples of the present disclosure will be described clearly and completely in the following with reference to the accompanying drawings in the examples of the present disclosure. Obviously, all the described examples are only some, rather than all examples of the present disclosure. Based on the examples in the present disclosure, all other examples obtained by those ordinary skilled in the art without creative efforts belong to the scope of protection of the present disclosure.

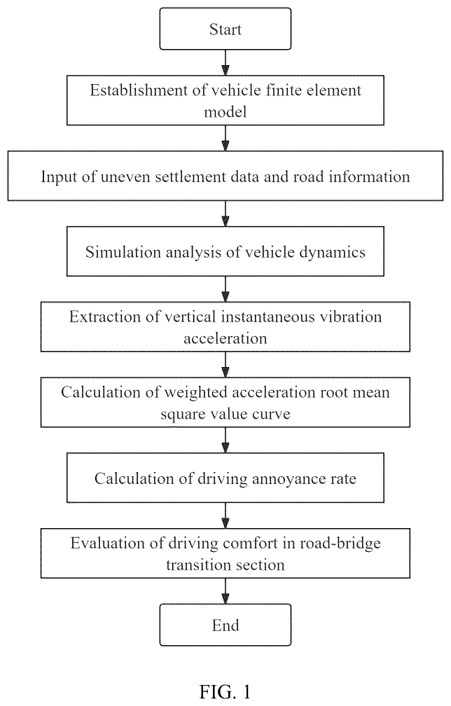

As shown in FIG. 1, a driving comfort evaluation method for uneven settlement of a road-bridge transition section in a soft soil area includes the following steps that:

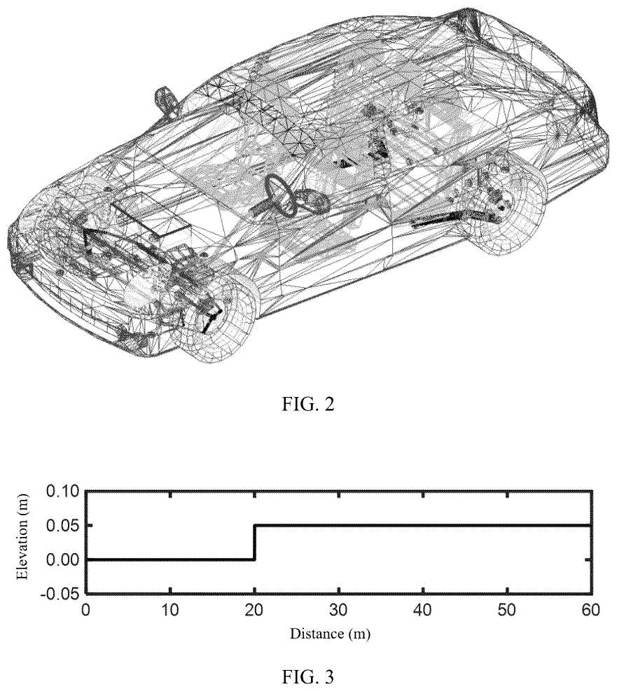

In step 1, a finite element model of a vehicle is established using a vehicle dynamics design and analysis software Adams/Car according to vehicle parameters of an actual family car; and as shown in FIG. 2, including six subsystems: a vehicle body system, a front suspension system, a rear suspension system, a front tire system, a rear tire system and a dynamic system, in which the front suspension system uses McPherson suspension and the rear suspension system uses multi-link suspension.

In step 2, the uneven settlement of the road-bridge transition section of a road center line is assumed to be an ideal staggered platform form, a design speed of the road is 100 km/h, and the uneven settlement elevation of a ground surface of the road-bridge transition section is shown in FIG. 3, in which a bridge deck and a pavement are horizontal, and the bridge deck is 5 cm higher than the pavement. Uneven settlement data of the road-bridge transition section (the longitudinal surface elevation data of the road, that is, a surface uneven settlement curve of the road-bridge transition section) and actual road information (including roughness and friction coefficient) are input into the vehicle finite element model as road parameters. In this example, a pavement unevenness level is set to B level, the road section friction coefficient is set to 0.9, and the bridge deck section friction coefficient is set to 0.8.

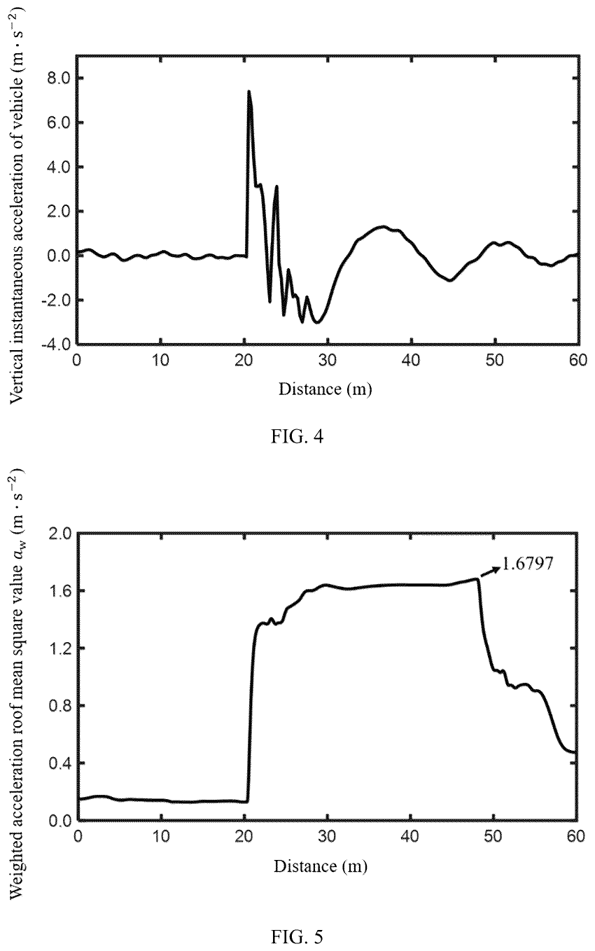

In step 3, the vehicle finite element model is used for dynamic simulation analysis, a vehicle speed is set as 100 km/h, and a driving process of the vehicle on the assumed ideal staggered platform type uneven settlement road of the road-bridge transition section is simulated; and in a simulation process, a driving direction of the vehicle can be the direction from a bridge on the road or a direction from the road under the bridge, and in this example, what is simulated is a direction from the road to the bridge. Through simulation analysis, vertical instantaneous vibration acceleration data of the vehicle body in the vehicle driving process is obtained, as shown in FIG. 4.

In step 4, a weighted acceleration root mean square curve is calculated according to the vertical instantaneous vibration acceleration data of the vehicle body obtained by simulation analysis. A calculation formula of the weighted acceleration root mean square value a_{w} is as follows:

$${a}_{w} ( t ) = {[ {\int }_{0.5}^{80} {( W ( u ) \cdot \vert \tilde{\ddot{y}} ( u ) \vert )}^{2} d u ]}^{\frac{1}{2}}$$

where t represents a certain moment; a_{w}(t) represents a weighted acceleration root mean square value at t. u is a frequency and an integral variable, with a value interval of 0.5-80.This calculation formula refers to the ISO2631 standard. The integral interval used in the standard is 0.5-80. The human body feels the vibration in this frequency range more obviously, and the vibration with frequencies less than 0.5 and greater than 80 is ignored. ∫ is an integral symbol and d is a differential symbol.

[symbol] (u) is the vertical instantaneous vibration acceleration of the vehicle body in a frequency domain frequency history, [symbol] (u) is obtained by converting the vertical instantaneous vibration acceleration of the vehicle body from a time domain to a frequency domain through Fourier transform in a time period of [t-τ, t]; where τ is a continuous average integration time, taking 1 s.

W(u) is a frequency domain weighting function, and the frequency domain weighting function W(u) is expressed as follows:

$$W ( u ) = \{ \begin{matrix}0.5 & ( 0.5 \leq u \leq 2. ) \\ u / 4 & ( 2. < u \leq 4. ) \\ 1 & ( 4. < u \leq 12.5 ) \\ 12.5 / u & ( 12.5 < u \leq 80. )\end{matrix}$$

A weighted acceleration root mean square curve calculated in this example is shown in FIG. 5.

In step 5, the maximum weighted acceleration root mean square value a_{w} in the driving process of the vehicle on the uneven settlement road in the road-bridge transition section as a representative weighted acceleration root mean square value is calculated according to the weighted acceleration root mean square curve. In this example, a_{w}=1.6797 m/s².

In step 6, a driving annoyance rate as a unified evaluation index of driving comfort of uneven settlement of road-bridge transition section in the soft soil area is calculated according to the representative weighted acceleration root mean square value a_{w}=1.6797 m/s², combined with an annoyance rate model (the annoyance rate model refers to the doctoral dissertation, Song Zhigang, THEORY OF VIBRATION COMFORT DESIGN OF ENGINEERING STRUCTURES BASED ON ANNOYANCE RATE MODEL, doctoral dissertation of Zhejiang University, 2003), and considering the randomness of human subjective feeling and the fuzziness of brain determination.

A calculation formula of the driving annoyance rate

$$A ( {a}_{w}^{′} )$$

is as follows:

$$A ( {a}_{w}^{′} ) = {\int }_{0.315}^{∞} f ( rms \vert {a}_{w}^{′} ) \cdot v ( rms ) \cdot d ( rms )$$

where

$${a}_{w}^{′}$$

is and objective vibration acceleration (that is, there is an objective root mean square value of vibration weighted acceleration) and the root mean square value of weighted acceleration felt by the human body under this objective vibration is rms. In a specific calculation process, the root mean square value a_{w} of the representative weighted acceleration calculated in the previous step is used as an input objective vibration to calculate), and rms is a vibration acceleration felt by the human body under a stimulation of the objective vibration acceleration

$${a}_{w}^{′} .$$

A random variable rms conforms to a lognormal distribution, and a variable coefficient is taken as 0.3 (Ref. M. J. Griffin, E. M. Whitham, Individual variability and its effect on subjective and biodynamic response to whole-body vibration, Journal of Sound and Vibration Volume 58, Issue 2, 22 May 1978, Pages 239-250).

$$f ( rms \vert {a}_{w}^{′} )$$

represents a probability density function of the root mean square value rms of acceleration felt by the random variable human body under a condition that a root mean square value of the objective vibration weighted acceleration is

$${a}_{w}^{′} ;$$

d is the differential symbol, indicating that rms is the integral variable. An integration range is from 0.315 to ∞. Referring to ISO2631 standard, the root mean square value of acceleration at the lower limit of human perception is 0.315.
where ν is a membership function, and an expression is as follows:

$$v ( rms ) = a \cdot ln ( rms ) + b$$

where ln(rms) represents taking the logarithm of rms; a and b are fitting coefficients. a is taken as 0.4827 and b is taken as 0.5577. The values of a and b refer to the ISO2631 standard. The root mean square value of acceleration at the lower limit of human perception is taken as 0.315 m/s², and the root mean square value of acceleration at the upper limit of human perception is taken as 2.5 m/s², which are substituted into a membership degree calculation formula to obtain: when rms=0.315 m/s², ν=a·ln(0.315)+b=0; and when rms=2.5 m/s², ν=a·ln(2.5)+b=1, solving for a=0.4827, b=0.5577.

In this example, a driving annoyance rate

$$A ( {a}_{w}^{′} ) = 0.7227$$

is calculated.

According to the calculated driving annoyance rate

$$A ( {a}_{w}^{′} ) = 0.7227 ,$$

that is, the number of people who feel unacceptable annoyance in the vehicle driving process accounts for 72.27% of the total number of people.

For those skilled in the art, it is obvious that the present disclosure is not limited to the details of the above exemplary examples, and can be realized in other examples without departing from the spirit or basic characteristics of the present disclosure. Therefore, from any perspective, the examples are to be regarded as exemplary and non-restrictive. The scope of the present disclosure is defined by the appended claims rather than the above description, and thus aims to incorporate all changes that fall within the meaning and scope of the equivalent conditions of the claims into the present disclosure. Any reference signs in the claim are not to be construed as limiting the claim concerned.

1. A driving comfort evaluation method for uneven settlement of a road-bridge transition section in a soft soil area, comprising the steps of:
(1) establishing a vehicle finite element model according to vehicle parameters;
(2) inputting uneven settlement data and road information of a road-bridge transition section into the vehicle finite element model in step (1) as road parameters;
(3) using the vehicle finite element model after inputting the road parameters in step (2) to perform dynamic simulation analysis, simulating a driving process of a vehicle on an uneven settlement road in the road-bridge transition section, and obtaining vertical instantaneous vibration acceleration data of a vehicle body in the driving process of the vehicle through simulation analysis;
(4) calculating a weighted acceleration root mean square curve according to the vertical instantaneous vibration acceleration data of the vehicle body obtained by the simulation analysis in step (3);
(5) calculating the maximum weighted acceleration root mean square value in the driving process of the vehicle on the uneven settlement road in the road-bridge transition section as a representative weighted acceleration root mean square value according to the weighted acceleration root mean square curve obtained in step (4); and
(6) calculating a driving annoyance rate as a unified evaluation index of driving comfort of uneven settlement of the road-bridge transition section in the soft soil area according to the representative weighted acceleration root mean square value obtained in step (5), combined with an annoyance rate model, and considering the randomness of human subjective feeling and the fuzziness of brain determination; wherein
in step (1), the vehicle is a family car, and the vehicle finite element model comprises a vehicle body system, a front suspension system, a rear suspension system, a front tire system, a rear tire system and a dynamic system;
in step (2), the uneven settlement of the road-bridge transition section of a road center line is assumed to be ideal staggered platform type, ideal curve type, ideal polyline type or measured highway surface settlement data;
the uneven settlement data of the road-bridge transition section is longitudinal surface elevation data of the road; and
in step (2), the road information comprises roughness and friction coefficient of the road;
in step (3), a set vehicle driving speed is 60-120 km/h when the dynamic simulation analysis is performed;
in step (4), the weighted acceleration root mean square value is a_{w}, and a calculation formula is as follows:
$${a}_{w} ( t ) = {[ {\int }_{0.5}^{80} {( W ( u ) \cdot \vert \tilde{\ddot{y}} ( u ) \vert )}^{2} d u ]}^{\frac{1}{2}}$$
where t represents a certain moment; a_{w}(t) represents a weighted acceleration root mean square value at t; u is a frequency and an integral variable, with a value interval of 0.5-80; and ∫ is an integral symbol and d is a differential symbol; [symbol]
(u) is the vertical instantaneous vibration acceleration of the vehicle body in a frequency domain frequency history, [symbol] (u) is obtained by converting the vertical instantaneous vibration acceleration of the vehicle body from a time domain to a frequency domain through Fourier transform in a time period of [t-τ, t];
where τ is a continuous average integration time;
W(u) is a frequency domain weighting function, and the frequency domain weighting function W(u) is expressed as follows:
$$W ( u ) = \{ \begin{matrix}0.5 & ( 0.5 \leq u \leq 2. ) \\ u / 4 & ( 2. < u \leq 4. ) \\ 1 & ( 4. < u \leq 12.5 ) \\ 12.5 / u & ( 12.5 < u \leq 80. )\end{matrix}$$
in step (6), the driving annoyance rate
$$A ( {a}_{w}^{′} )$$
is calculated as follows:
$$A ( {a}_{w}^{′} ) = {\int }_{0.315}^{∞} f ( rms \vert {a}_{w}^{′} ) \cdot v ( rms ) \cdot d ( rms )$$
where
$${a}_{w}^{′}$$
is an objective vibration acceleration, and the value is the representative weighted acceleration root mean square value obtained in step (5); and rms is a vibration acceleration felt by the human body;
under a stimulation of the objective vibration acceleration
$${a}_{w}^{′} ,$$
a random variable rms conforms to lognormal distribution, and a variable coefficient is 0.1-0.5;
$$f ( r m s \vert {a}_{w}^{′} )$$
represents a probability density function of the root mean square value rms of acceleration felt by the random variable human body under a condition that a root mean square value of the objective vibration weighted acceleration is
$${a}_{w}^{′} ;$$
∫ is the integral symbol and d is the differential symbol;
where v is a membership function, and an expression is as follows:
$$v ( r m s ) = a \cdot ln ( r m s ) + b$$
where a and b are fitting coefficients.

2. A driving comfort evaluation device for uneven settlement of a road-bridge transition section in a soft soil area, comprising a vehicle finite element model construction unit, a dynamic simulation analysis unit, a weighted acceleration root mean square value calculation unit, and a driving annoyance rate calculation unit, wherein
the vehicle finite element model building unit is configured to establish a vehicle finite element model according to vehicle parameters, and further input uneven settlement data and road information of a road-bridge transition section into the vehicle finite element model as road parameters;
the dynamic simulation analysis unit is configured to perform dynamic simulation analysis using the vehicle finite element model after inputting the road parameters, simulate a driving process of the vehicle on the uneven settlement road of the road-bridge transition section, and obtain vertical instantaneous vibration acceleration data of a vehicle body in the driving process of the vehicle through simulation analysis;
the weighted acceleration root mean square value calculating unit is configured to calculate a weighted acceleration root mean square value curve according to the vertical instantaneous vibration acceleration data of the vehicle body obtained by simulation analysis; and calculate the maximum weighted acceleration root mean square value in the driving process of the vehicle on the uneven settlement road in the road-bridge transition section as a representative weighted acceleration root mean square value according to the obtained weighted acceleration root mean square curve; and
the driving annoyance rate calculation unit calculates the driving annoyance rate as a unified evaluation index of driving comfort of uneven settlement of the road-bridge transition section in the soft soil area according to the obtained representative weighted acceleration root mean square value, combined with an annoyance rate model, and considering the randomness of human subjective feeling and the fuzziness of brain determination;
the vehicle is a family car, and the vehicle finite element model comprises a vehicle body system, a front suspension system, a rear suspension system, a front tire system, a rear tire system and a dynamic system;
the uneven settlement of the road-bridge transition section of a road center line is assumed to be ideal staggered platform type, ideal curve type, ideal polyline type or measured highway surface settlement data;
the uneven settlement data of the road-bridge transition section is longitudinal surface elevation data of the road; and
the road information comprises roughness and friction coefficient of the road;
the weighted acceleration root mean square value is a_{w}, and a calculation formula is as follows:
$${a}_{w} ( t ) = {[ {\int }_{0.5}^{80} {( W ( u ) \cdot \vert \tilde{\ddot{y}} ( u ) \vert )}^{2} du ]}^{\frac{1}{2}}$$
where t represents a certain moment; a_{w}(t) represents a weighted acceleration root mean square value at t; u is a frequency and an integral variable, with a value interval of 0.5-80; and
∫ is an integral symbol and d is a differential symbol; [symbol]
(u) is the vertical instantaneous vibration acceleration of the vehicle body in a frequency domain frequency history, [symbol] (u) is obtained by converting the vertical instantaneous vibration acceleration of the vehicle body from a time domain to a frequency domain through Fourier transform in a time period of [t-τ, t];
where τ is a continuous average integration time;
W(u) is a frequency domain weighting function, and the frequency domain weighting function W(u) is expressed as follows:
$$W ( u ) = \{ \begin{matrix}0.5 & ( 0.5 \leq u \leq 2. ) \\ u / 4 & ( 2. < u \leq 4. ) \\ 1 & ( 4. < u \leq 12.5 ) \\ 12.5 / u & ( 12.5 < u \leq 80. )\end{matrix}$$
in step (6), the driving annoyance rate
$$A ( {a}_{w}^{′} )$$
is calculated as follows:
$$A ( {a}_{w}^{′} ) = {\int }_{0.315}^{∞} f ( r m s \vert {a}_{w}^{′} ) \cdot v ( r m s ) \cdot d ( r m s )$$
where
$${a}_{w}^{′}$$
is an objective vibration acceleration, and the value is the representative weighted acceleration root mean square value obtained in step (5); and rms is a vibration acceleration felt by the human body;
under a stimulation of the objective vibration acceleration
$${a}_{w}^{′} ,$$
a random variable, rms conforms to lognormal distribution, and a variable coefficient is 0.1-0.5;
$$f ( r m s \vert {a}_{w}^{′} )$$
represents a probability density function of the root mean square value rms of acceleration felt by the random variable human body under a condition that a root mean square value of the objective vibration weighted acceleration is
$${a}_{w}^{′} ;$$
∫ is the integral symbol and d is the differential symbol;
where ν is a membership function, and an expression is as follows:
$$v ( r m s ) = a \cdot ln ( r m s ) + b$$
where a and b are fitting coefficients.

3. A driving comfort evaluation apparatus for uneven settlement of a road-bridge transition section in a soft soil area, comprising a memory and a processor, wherein the memory is used for storing a computer program, and the processor is used for implementing the driving comfort evaluation method for uneven settlement of a road-bridge transition section in a soft soil area according to claim 1 when the computer program is executed.
